(19) United States
(12) Patent Application Publication
(10) Pub. No.: US 2007/0289665 A1
(43) Pub. Date: Dec. 20, 2007

(54) CONTAINER TRANSPORTATION LINE BOTTLING PLANTS

(75) Inventors: Giovanni MAZZON, San Bonifacio (VR) (IT); Franco Balzarin, Pressana (VR) (IT); Sergio Ciocchetta, Pradamano (UD) (IT)

Correspondence Address: BROWDY AND NEIMARK, P.L.L.C.;624 NINTH STREET, NW, SUITE 300, WASHINGTON, DC, 20001-5303, US

(73) Assignee: MBF S.p.A., Veronella (VR) (IT)

(21) Appl. No.: 11/758,834

(22) Filed: Jun. 6, 2007

(30) Foreign Application Priority Data
Jun. 6, 2006 (IT) PD2006A 000226

(51) Int. Cl. B67C 3/00

(52) U.S. Cl. 141/165

(57) ABSTRACT

Container transportation line for bottling plants, comprising transportation means provided with a support surface for receiving, resting thereon, the containers and with a motor-driven chain having, connected thereto, a plurality of ribs with a constant interval delimiting a plurality of first seats for the containers movable on the support surface. Adjustment means are provided for varying the position of the ribs with respect to the first chain depending on the dimensions of the containers, as well as means for performing transfer from the transportation means to at least one operating machine formed by a rotating starwheel associated with the operating machine and provided with a plurality of second seats formed in the recesses of the starwheel and intended to receive in synchronism the containers from the first seats, resting on flanges associated with the seats. Adjustment of the position of the ribs by means of the first adjustment means determines the synchronism between the transportation means and the transfer means upon variation in the form of the containers. Second adjustment means are also provided for varying the angular position of the flanges with respect to the starwheel.

### FIELD OF APPLICATION

The present invention relates to a container transportation line for bottling plants according to the preamble of claim 1. The line in question can advantageously be used for guiding the containers to the machines which form a bottling line, including, typically, a rinsing machine, a filling machine and a corking/capsuling machine or also, in the part situated furthest downstream along the line, a labeling machine and a packaging machine.

Therefore, the line in question is classifiable within the sector of the industry for bottling alimentary liquids such as wine, mineral water, hard liquors and beverages in general.

### BACKGROUND ART

A modern bottling line, in particular for bottling alimentary products, normally comprises three basic machines, which are:
a rinsing machine, in which the containers are washed and sterilized;
a filling machine, in which the liquid product is transferred from the storage tank into the container;
a corking/capsuling machine, in which the container is sealed hermetically.

Downstream there may also be provided a labeling machine and a packaging machine as well as other ancillary machines.

The abovementioned machines are linked together within a single integrated process by means of bottle transfer and feeding systems. In more detail, the containers are loaded onto conveyor belts which convey them to the individual machines. From the conveyors the containers are then transferred onto a starwheel device, which is synchronized and integral with the machine, so that the position of each container corresponds exactly to the position of the operating component of the machine, which may be, depending on the machine considered, respectively: a filling nozzle, a washing nozzle, a corking device, a label applicator or the like.

On the outlet side of the machine the container is transferred by other starwheel or feed screw systems onto the following machine, and the container gradually passes through the rinsing machine, the bottling machine, the corking machine, until it reaches the labeling machine.

Obviously, it is necessary to maintain the synchronism and the correct timing along the whole line so that the relative position of the bottle and the operating component of the machine is always maintained. In order to achieve this, the starwheels and the other container transportation and guiding parts have a dimensions and a shape corresponding to the dimensions of the container, such that the container is seated precisely inside them.

Recently, as is well known, in particular in the sector of hard liquors, distilled alcohol, etc., but also beverages, there is a tendency to use bottles which have a varying format, being different in terms of shape (with a square, circular or oval base), dimensions or volume, sometimes with the use of intricate geometrical forms. In this way, the need from a marketing point of view to provide products which attract the consumer's interest and attention is satisfied.

Depending on these marketing requirements, the production within the bottling companies is performed in fairly small batches with frequent production change-overs. Therefore a need which exists in the bottling industry sector may be regarded as that of being able to have highly flexible plants. This need has been addressed both by the leading bottling establishments, which produce a large variety of products and formats, and by smaller size bottling firms, cellars and distilleries, which typically work with small batches and which need to have flexible and highly productive plants.

In connection with the above, however, each production change-over requires setting-up of the line, which is a fairly complex operation. It is in fact necessary to adjust manually all the container guiding and transporting devices and also replace the conveying starwheels of the rinsing unit, bottling unit, etc. In other words, this involves the operator carrying out personally adjustment of mechanical components, cams, mechanical adjusters, etc., with a considerable risk of injury. As is known, in accordance with the present state of the art, it is in fact possible to vary electronically only the operating parameters of each individual unit, such as, for example, the delivery time of the nozzle, or the speed of rotation of the machine.

The adjustment operations are usually complex and necessarily require direct action on the part of the operator and in particular result in a prolonged stoppage of the line which overall may amount to as much as 50% of the total time.

Some manufacturers have recently proposed on the market a (partial and unsatisfactory) solution to these problems which, however, involves radically changing the layout of the entire line and the individual working units. The known solution proposed envisages forming an annular line where the bottles move resting on special cup-like supports. The rinsing machine, bottling machine etc., are arranged along the line and have a linear extension instead of the conventional circular carousel configuration. The limitations of these plants are, firstly, the considerable length of the bottling line, which is far greater than that of conventional lines (where, instead, it is attempted to keep the plant as compact as possible and isolate it from the external environment), but in particular the fact that transportation in the cup-like seat involves modifying also each rinsing, bottling or other machine, both from a constructional and from a functional point of view, with obvious problems of cost and loss of efficiency and reliability compared to the conventional lines where the technology is now already consolidated.

### DISCLOSURE OF THE INVENTION

The main object of the present invention is therefore to overcome the drawbacks associated with the solutions of the known type by providing a container transportation line for bottling plants which is able to bottle containers of different form and size, without the need to perform long and complex setting operations.

A further object of the present invention is to provide a transportation line which is able to be used in order to feed machines based on conventional technology such as rinsing machines, filling machines, corking machines, etc., without having to adapt their operating principle.

A further object of the present invention is to provide a transportation line which is operationally entirely reliable and which allows a high performance to be achieved for the entire bottling line.

Another object of the present invention is to provide a transportation line with compact dimensions.

Another object of the present invention is to provide a versatile transportation line so as to form bottling lines with different characteristics in terms of productivity, operating range, layout, etc.

Another object of the present invention is to provide a transportation line with a high degree of safety for the personnel working on the bottling line.

### BRIEF DESCRIPTION OF THE DRAWINGS

The technical features of the invention, in accordance with the abovementioned objects, may be clearly determined from the contents of the claims provided below and the advantages thereof will emerge more clearly from the detailed description which follows, provided with reference to the accompanying drawings which illustrate a purely exemplary and non-limiting embodiment thereof in which:

FIG. 1 shows a schematic plan view of a section of the container transportation line for bottling plants, according to the present invention;

FIG. 2 shows a schematic plan view of a detail of the line according to FIG. 1, relating to means for transferring the containers;

FIGS. 2A and 2B show two schematic views of an enlarged detail of the transfer means according to FIG. 2, relating to grippers and to their actuating means;

FIG. 3 shows a schematic side view of the container transfer means according to FIG. 2;

FIG. 4 shows an enlarged detail of FIG. 3, relating to means for adjusting the height of the grippers;

FIG. 5 shows an enlarged view of a detail of the line 1, relating to the support base of the containers.

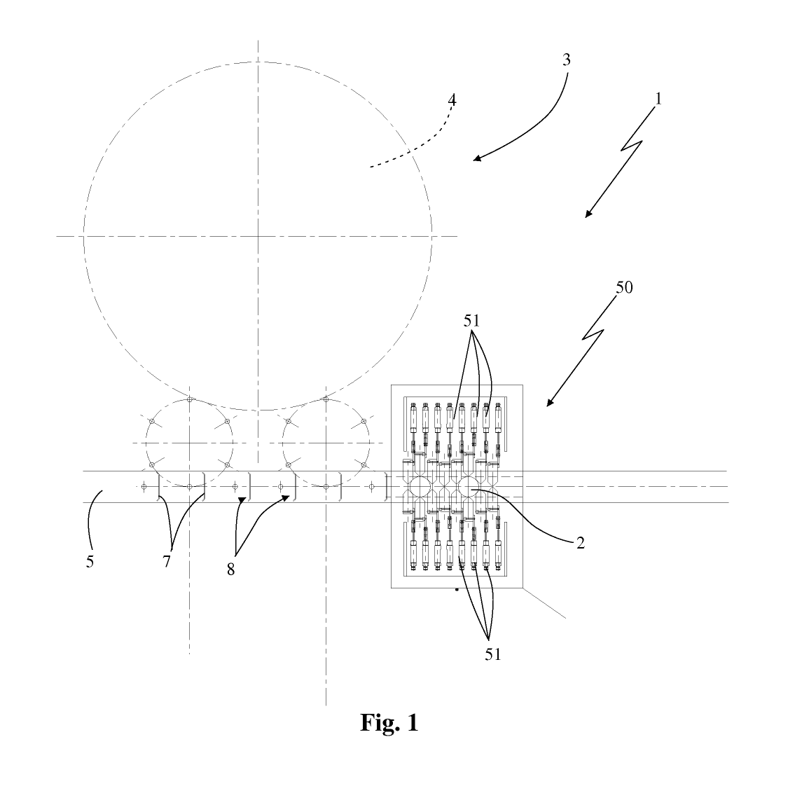

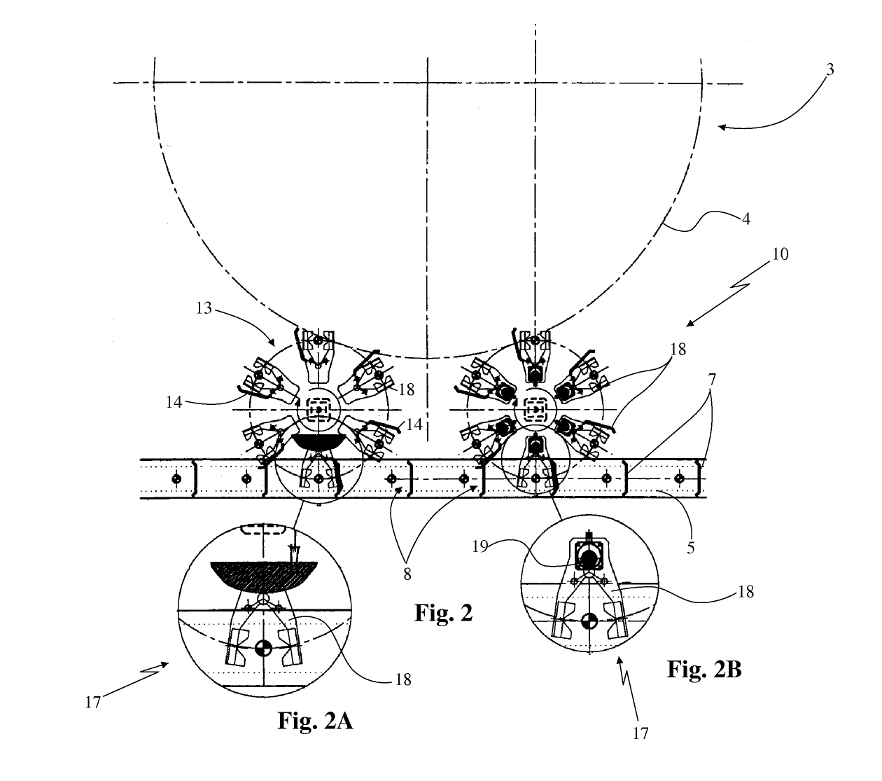

### DETAILED DESCRIPTION OF A PREFERRED EXAMPLE OF EMBODIMENT

With reference to the attached drawings 1 denotes in its entirety the line for transporting containers 2 for bottling plants, according to the present invention.

The transportation line 1 is intended to transport the containers between the different operating machines 3 which usually form an industrial bottling plant, including usually a rinsing machine, in which the containers are washed and sterilized; a filling machine, in which the liquid product is transferred from a storage tank into the container; a corking/capsuling machine, in which the container is sealed hermetically and if necessary along more complete lines also a labeling machine and a packaging machine, together with other ancillary machines.

These machines comprise a rotating carousel 4 around which the containers 2 travel and which has a plurality of operating heads able to perform the various operations on the passing containers, depending on the type of machine involved.

In accordance with the idea forming the basis of the present invention, the line 1 is provided with transportation means comprising a horizontal support surface 5 on which the containers 2 are placed so as to rest with their base. This support surface is bounded laterally by parallel side shoulders 30 which may be moved towards or away from each other automatically depending on the dimensions of the containers 1.

The support surface 5 is mechanically connected at the bottom to a motor-driven chain 6 which is endlessly wound on pulleys, of which at least one is operated by means of a motor, in particular of the electronically controlled brushless type, it obviously also being possible to use a d.c. or an asynchronous motor. The chain 6 extends with at least one operating section arranged parallel to the extension of the support surface 5, and at least one return section able to close the loop of the chain 6.

The chain 6 has, fixed along it, at regular distances with a constant interval, a plurality of ribs 7 which define a plurality of corresponding first seats 8 on the support surface 5, able to receive the containers 2. In more detail, the ribs 7 extend upwards vertically from the support surface 5, connected with feet to the support base 5 of the chain.

The ribs 7, receiving resting against them the containers, determine in a precise manner the positioning thereof along the chain 6 for synchronism of the feeding movement of the containers with the various operating machines as described further below.

Following the advancing movement of the chain 6, the containers 2 are pushed by the ribs so as to move together with the support surface 5 along the entire operating section of the chain 6.

Adjustment means are provided for varying the absolute position of the ribs 7 in order to maintain always the synchronism with the operating machines of the system upon variation in the size of the containers 2.

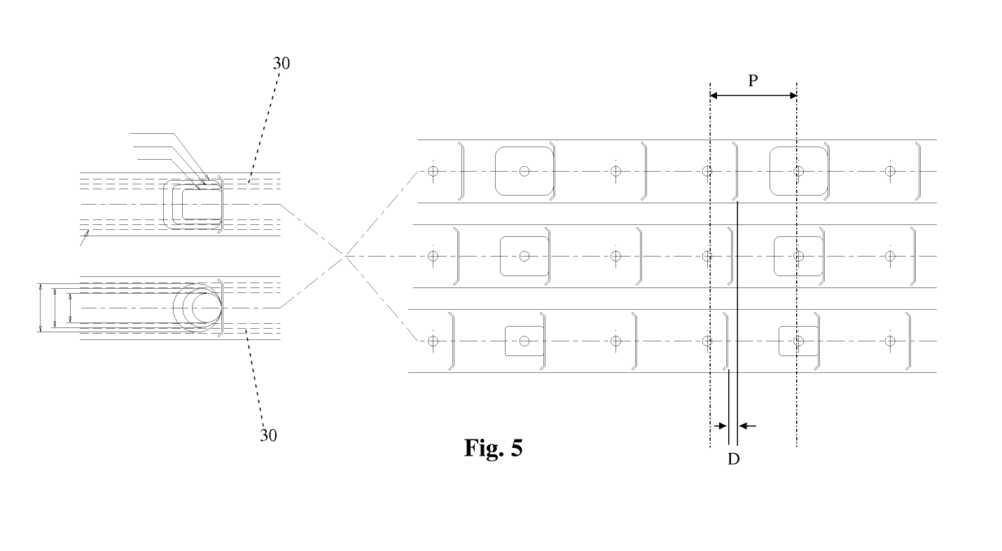

As can be clearly understood from the accompanying FIG. 5, it is in fact necessary to vary the position of the ribs 7 when there is a variation in the format of the containers in order to maintain the synchronism with the machines, determined by the interval between the containers.

In accordance with the example according to FIG. 5, the ribs spaced by the interval P must be delayed by the distance D when there is an increase in the dimensions of the containers.

Preferably, the first adjustment means are simply obtained by means of the control electronics of the first motor, which allow the movement of all the ribs 7 to be advanced or delayed as a whole, so as to keep them with the same interval in synchronism with the individual operating machines upon variation in the size of the containers 2.

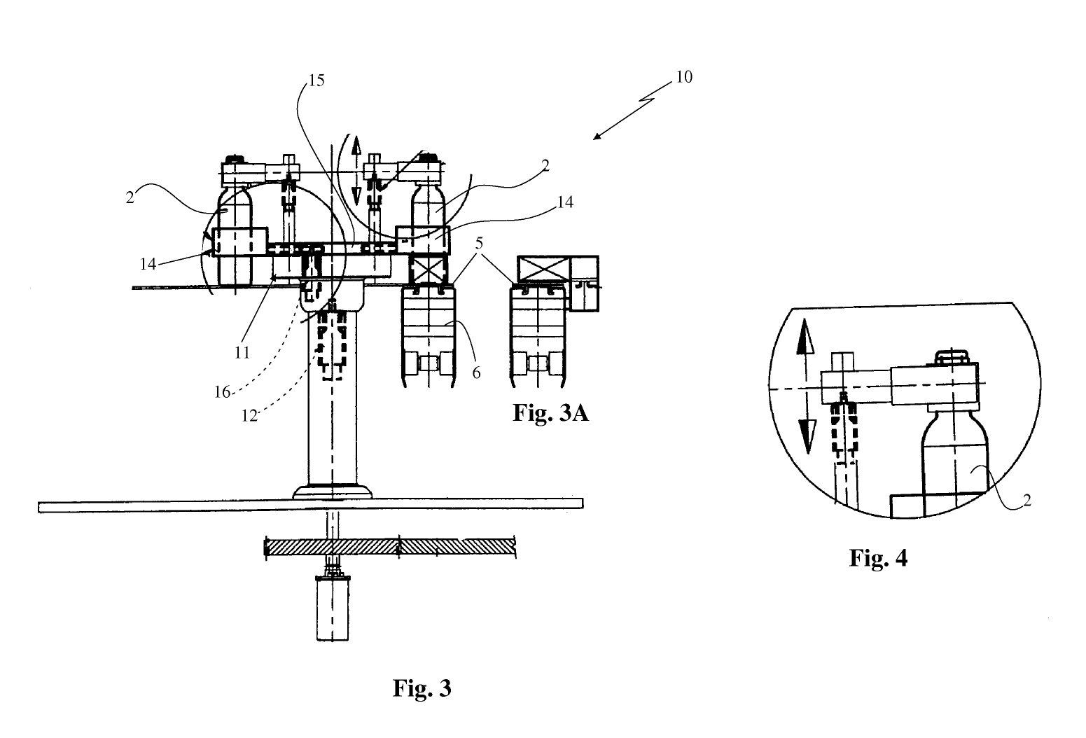

In accordance with a constructional variant of the present invention, indicated in FIG. 3A, the ribs 7 may be fixed to a second motor-driven chain 9 which travels along the operating section parallel to the chain 6 supporting the containers 2 and in a position alongside. The adjustment in this case is obtained by varying the relative position of the two chains, setting the second motor which controls the displacement of this second chain 9 so as to operate with a delay or advance for example.

In accordance with a further constructional variant of the present invention, not shown in detail in the accompanying figures, the support surface 5 may be fixed and the ribs, fixed to a motor-driven chain arranged to one side of the support surface 5, will slidably displace the containers on top of the said surface suitably made of material with a low coefficient of friction.

The adjustment in this case is achieved by adjusting electronically the motor driving the chain which moves the ribs and which therefore determines the position of the containers for synchronization of the components downstream.

The entry of the containers 2 onto the transportation means described above as well as exit thereof in synchronism with the interval of the ribs 11 may be managed by special loading and unloading machines synchronized with the interval of the chain 6.

Alternatively, the containers 2 may arrive grouped together in a single file on the base 5 of the chain 6 where, instead of the conventional feed screw for spacing the containers 2 in accordance with the interval of the operating machines, a spacing apparatus 50 will advantageously be provided, being able to modify its configuration so as to adapt to the different formats of the said containers 2.

In greater detail, this apparatus 50 comprises on the two sides of the chain 6 above the support surface 5 a plurality of actuators 51 arranged alongside each other and able to be operated so as to push the containers 2 in the direction of forward movement of the chain 6.

The ends of the actuators 51 have, fixed thereto, suitably shaped stems 52 which define a receiving seat for the containers, which, as a result of synchronized operation of the actuators, is displaced with respect to the support base 5 until the individual containers 2 are spaced in accordance with the interval defined by the ribs 11 and in synchronism with the latter.

Obviously control of the actuators 51 is performed by the same logic control unit of the line.

Each operating machine 3 is moreover provided with transfer means 10 able to pick up the containers 2 from the support surface 5 and subject them to the programmed operations by the heads of the operating machine concerned.

These transfer means 10 comprise, with particular reference to FIG. 3, a first starwheel 11 which is made to rotate in synchronism with the carousel carrying the working heads of the operating machine 3 by a central shaft operated by a third motor 12 arranged preferably coaxially inside a support column of the starwheel. Alternatively, in accordance with a different example of embodiment in the same FIG. 3, the first starwheel 11 may be rotationally driven by the same starwheel 4 by means of transmission means consisting, for example, of simple gearwheels which are mechanically active on the central shaft.

The first starwheel 11 has recesses defining a plurality of second seats 13 bounded, at least partially, by flanges 14 intended to receive the containers 2 resting against them.

The synchronism between the first starwheel 11 which rotates and the feeding movement of the containers 2 on the support surface 5 which allows the containers to pass from the first seats 8 into the second seats 13 is ensured by the first adjustment means.

Adjustment means are also provided for varying the angular position of the containers 2 on the first starwheel 11. These means are preferably formed by a second starwheel comprising a disk-shaped part 15 with the flanges 14 fixed radially thereon. The disk-shaped part 15 is rigidly connected to the central shaft of the starwheel 11 and its relative position with respect to the latter is adjusted precisely by an actuator or fourth motor 16 which therefore has the function of varying the position of the containers on the starwheel 11 upon variation in their format in order to keep them in synchronism with the heads of the rotating carousel 4.

In greater detail, the actuator or fourth motor 16 causes a controlled relative rotation of the disk-shaped part 15 which carries the radially fixed flanges with respect to the first starwheel and the drive shaft.

The motor 16 may advantageously be a brushless motor or a stepper motor or a motor with inverter or other motor able to modify the position of the container when there is a variation in their format so as to re-establish the synchronism with the heads of the operating machine 3 which are mounted on the rotating carousel 4.

The transfer means moreover comprise gripping means 17 for picking up the containers 3 from the second seats 13 and subjecting them to the action of the heads of the operating machine 3.

These gripping means are provided with a plurality of grippers 18 which, in number, are equal to the number of second seats 13 and a submultiple of the number of operating heads of the machine 3. The grippers 18 are fixed to the first starwheel 11 by means of uprights and are angularly spaced in accordance with the interval of the second seats 13. The grippers 18 are kept operationally in synchronism with the heads arranged on the rotating carousel 4 of the machine 3 when there is a variation in the form of the containers 2 owing to adjustment of the position of the flanges 14 by means of the second adjustment means.

Third adjustment means are also provided for varying the gripping position of the grippers 18 on the neck of the containers 2 and fourth adjustment means are provided for varying the degree of opening of the grippers 18 depending on the width of the neck of the containers.

The third adjustment means are obtained with an electronically controlled linear actuator able to move vertically the framework supporting the grippers 18 or the first starwheel 11.

Alternatively, as indicated in FIG. 3, the third adjustment means may envisage the use of a linear actuator on each support upright of the gripper 18 which is also controlled electronically in order to vary the height of the grip depending on the format of the container 2.

The fourth adjustment means may be obtained by means of a stepper motor 19 able to move an eccentric pin able to interfere with the levers of the grippers 18 which are pivotably hinged together and consequently open them in a controlled manner. Resiliently yielding means are provided for the closing return movement of the grippers 18.

Opening of the grippers 18 may alternatively be performed by the action of a cam which is fixed with respect to the grippers transported by the first starwheel 11 and the position of which can be adjusted radially so as to vary opening of the levers of the said grippers 18.

The transportation line 1 according to the present invention is able to maintain the synchronism between all the machines required with a variation in the format of the containers 2.

This result is made possible by the transportation means, the transfer means and the various adjusting means described above, which are all controlled and managed by a logic control unit, which ensures correct interfacing between the individual machines and between the latter and the transportation and transfer means.

In accordance with the present invention, the operating machines such as the rinsing machine, bottling machine, etc., may be of the conventional rotating carousel type, which are modified only with regard to incorporation therein of the novel starwheel and the associated gripping means.

The operating principles of the operating machines already known, such as the filling, washing or corking procedures, as well as the sequence of operating steps, may remain substantially unvaried.

Overall, therefore, the novel line will have a layout which is similar to that of the present compact lines and will consist of the various operating machines connected together by means of the novel transportation line, so as to create a single integrated process, starting with handling of the empty container and ending with final packaging.

Operationally speaking, depending on the type of format of the container used, the operator will retrieve from the memory of the logic control unit the corresponding working sequence and, on the basis of the data stored in it, the control unit will operate the first adjustment means for arrangement of the bottles, so as to vary the position assumed by the transportation means, and adjust the second, third and if necessary fourth adjustment means for the transfer means, so as to vary the position of the bottles in the starwheels and also modify the operating characteristics of the grippers (gripping position and degree of opening of the grippers). The control unit will also adjust, in accordance with predefined operating steps determined by the format of the containers, the actuators 51 of the spacing apparatus 50 so as to introduce them onto the support surface of the transportation means in synchronism with the ribs. Finally, the control unit will perform, in accordance with the sequence of the format of the selected container, adjustment of the working parameters of each machine as regards, for example, the position of the filling nozzle, the washing and filling times, etc. It is pointed out that these latter adjustments already exist on the present machines, but the possibility of adjustment is limited to the operating parameters, while, as specified previously, the setting of the other devices described for the change of format of the container must be performed manually.

The control unit, in terms of its hardware and software as a whole, will coordinate, thanks to the means specified above, the implementation of all the adjustments, which are related to each other, ensuring adjustment of all the devices for the changing the format of the containers.

The invention thus conceived therefore achieves the predefined objects.

Obviously it may assume, in its practical embodiment, also forms and configurations which are different from that described above without, thereby, departing from the present scope of protection. Moreover, all the details may be replaced by technically equivalent elements and the forms, dimensions and the materials used may be of any nature according to requirements.

What is claimed:

1. A container transportation line for bottling plants of the type provided with several operating machines of the rotating carousel type, each carrying peripherally a plurality of operating heads, including in particular a rinsing machine, a filling machine and a corking/capsuling machine, comprising:
transportation means which comprise:
a support surface for receiving said containers resting thereon;
an endlessly wound motor-driven chain, with at least one operating section associated with said support surface, having connected thereto, a plurality of ribs with a constant interval delimiting a plurality of first seats for said containers, able to move said containers arranged on said support surface following the advancing movement of said first chain;
first adjustment means able to vary the position of said ribs with respect to said first chain depending on the dimensions of the containers;
means for performing transfer from said transportation means to at least one operating machine comprising:
at least one rotating starwheel associated with said operating machine and provided with a plurality of second seats formed in the recesses of the starwheel and intended to receive in synchronism the containers from said first seats, resting on flanges associated with the seats, the adjustment of the position of said ribs by means of said first adjustment means determining the synchronism between said transportation means and said transfer means upon variation in the form of the containers;
second adjustment means able to vary the angular position of said flanges with respect to said starwheel.

2. The transportation line as claimed in claim 1, wherein said transfer means also comprise means for gripping said containers, able to displace the latter from said second seats to the working heads of said operating machines and provided with a plurality of grippers which are angularly spaced at the angular interval of said second seats, and in synchronism with said heads upon variation in the form of the containers following adjustment of the position of said flanges by means of said second adjustment means.

3. The transportation line as claimed in claim 1, wherein the second seats of said starwheel are, in number, a submultiple of the number of operating heads of said machine.

4. The transportation line as claimed in claim 2, wherein said transfer means comprise third adjustment means for varying the gripping height of said grippers on the neck of said containers.

5. The transportation line as claimed in claim 2, wherein said transfer means comprise four adjustment means for varying opening of said grippers depending on the width of the neck of said containers.

6. The transportation line as claimed in claim 1, wherein said ribs are fixed to said first chain.

7. The transportation line as claimed in claim 1, wherein said first adjustment means are achieved by means of control of the first motor driving said first chain.

8. The transportation line as claimed in claim 1, wherein said first transportation means comprise a second chain having said ribs fixed thereon and being moved by a second motor along an operating section parallel to said first chain and at the same speed as the latter.

9. The transportation line as claimed in claim 8, wherein said first adjustment means are achieved by means of control of the second motor driving said second chain.

10. The transportation line as claimed in claim 1, wherein said chain moves said containers on said fixed support surface by means of said ribs for said operating section.

11. The transportation line as claimed in claim 7 or 9, wherein said first or second electric motor is of the brushless type, stepper type or controlled by an inverter.

12. The transportation line as claimed in claim 1, wherein said second adjustment means comprise a second carousel or a frame with said flanges fixed radially, able to be displaced by means of a third motor which is electronically controlled with respect to said starwheel.

13. The transportation line as claimed in claim 12, wherein said third motor is of the brushless type, stepper type or controlled by an inverter.

14. The transportation line as claimed in claim 4, wherein said third adjustment means comprise at least one linear actuator able to move at least one said gripper to different heights depending on the form of said containers.

15. The transportation line as claimed in claim 5, wherein said fourth adjustment means comprise stepper motors, each able to control in a controlled manner opening of the levers of each gripper which are pivotably hinged together and subject to a resilient recall force.

16. The transportation line as claimed in claim 5, wherein said fourth adjustment means comprise at least one cam which is fixed with respect to the first starwheel, displaceable radially and able to interfere with the levers of each gripper pivotably hinged together and subject to a resilient recall force for causing opening and closing thereof.

17. The transportation line as claimed in claim 1, comprising a spacing apparatus arranged so as to intercept said transportation means and provided with a plurality of actuators arranged alongside each other and able to be operated in predefined operating steps so as to push the containers in the direction of forward movement of the chain, spacing them in accordance with the interval of the ribs and in synchronism with the latter upon variation in the size of the containers.
